(19) United States
(12) Patent Application Publication
(10) Pub. No.: US 2020/0042193 A1
(43) Pub. Date: Feb. 6, 2020

(54) METHOD, STORAGE SYSTEM AND COMPUTER PROGRAM PRODUCT FOR MANAGING DATA STORAGE

(71) Applicant: EMC IP Holding Company LLC, Hopkinton, MA (US)

(72) Inventors: Nickolay A. Dalmatov, St. Petersburg (RU); Michael Patrick Wahl, Bulverde, TX (US); Jian Gao, Beijing (CN)

(21) Appl. No.: 16/054,122

(22) Filed: Aug. 3, 2018

(51) Int. Cl. G06F 3/06

(52) U.S. Cl. CPC G06F 3/0616; G06F 3/0653; G06F 3/0632; G06F 3/0673; G06F 3/0659

(57) ABSTRACT

There is disclosed techniques for use managing data storage. In one embodiment, endurance values are generated in connection with a plurality of solid state drives (SSDs). Each endurance value for an SSD indicating an estimated number of write operations that may be performed on the SSD before the SSD wears out and requires replacement. Additionally, storage space is reserved on one or more of the SSDs such that an endurance level associated with the endurance value of the SSD will have an inverse relationship with the amount of storage space reserved on the SSD.

### TECHNICAL FIELD

The present invention relates generally to data storage. More particularly, the present invention relates to a method, a storage system and a computer program product for managing data storage.

### BACKGROUND OF THE INVENTION

Systems may include different resources used by one or more host processors. Resources and host processors in the system may be interconnected by one or more communication connections, such as network connections. These resources may include, for example, data storage devices such as those included in the data storage systems manufactured by Dell EMC. These data storage systems may be coupled to one or more host processors and provide storage services to each host processor. Multiple data storage systems from one or more different vendors may be connected and may provide common data storage for one or more host processors in a computer system.

A host may perform a variety of data processing tasks and operations using the data storage system. For example, a host may perform basic system I/O (input/output) operations in connection with data requests, such as data read and write operations.

Host systems may store and retrieve data using a data storage system containing a plurality of host interface units, disk drives (or more generally storage devices), and disk interface units. Such data storage systems are provided, for example, by Dell EMC of Hopkinton, Mass. The host systems access the storage devices through a plurality of channels provided therewith. Host systems provide data and access control information through the channels to a storage device of the data storage system and data of the storage device is also provided from the data storage system to the host systems also through the channels. The host systems do not address the disk drives of the data storage system directly, but rather, access what appears to the host systems as a plurality of files, objects, logical units, logical devices or logical volumes. These may or may not correspond to the actual physical drives. Allowing multiple host systems to access the single data storage system allows the host systems to share data stored therein.

Storing and safeguarding electronic content is of paramount importance in modern business and various methodologies may be employed to protect such electronic content. Unfortunately, complex system often require complex tasks (e.g., load balancing and wear balancing) to be performed in order to maintain protection of electronic content.

### SUMMARY OF THE INVENTION

There is disclosed a method, comprising: generating endurance values in connection with a plurality of solid state drives (SSDs), each endurance value for an SSD indicating an estimated number of write operations that may be performed on the SSD before the SSD wears out and requires replacement; and reserving storage space on one or more of the SSDs such that an endurance level associated with the endurance value of the SSD will have an inverse relationship with the amount of storage space reserved on the SSD.

There is also disclosed a data storage system, comprising control circuitry that includes a set of processing units coupled to memory, the control circuitry constructed and arranged to: generate endurance values in connection with a plurality of solid state drives (SSDs), each endurance value for an SSD indicating an estimated number of write operations that may be performed on the SSD before the SSD wears out and requires replacement; and reserve storage space on one or more of the SSDs such that an endurance level associated with the endurance value of the SSD will have an inverse relationship with the amount of storage space reserved on the SSD.

There is also disclosed a computer program product including a set of non-transitory, computer-readable media having instructions which, when executed by control circuitry of a data storage system, cause the control circuitry to perform a method, the method comprising: generating endurance values in connection with a plurality of solid state drives (SSDs), each endurance value for an SSD indicating an estimated number of write operations that may be performed on the SSD before the SSD wears out and requires replacement; and reserving storage space on one or more of the SSDs such that an endurance level associated with the endurance value of the SSD will have an inverse relationship with the amount of storage space reserved on the SSD.

### BRIEF DESCRIPTION OF THE DRAWINGS

The invention will be more clearly understood from the following description of preferred embodiments thereof, which are given by way of examples only, with reference to the accompanying drawings, in which:

FIG. 1 is a block diagram showing an example environment in which embodiments of an improved technique can be practiced;

FIG. 2 is a diagrammatic view of a portion of the storage system of FIG. 1;

FIG. 3 is a diagrammatic view of a portion of the storage system of FIG. 1; and

FIG. 4 is a flowchart showing an example method of managing data storage.

### DETAILED DESCRIPTION

Balancing wear across solid state drives (SSDs) is important in order to maximize the performance of a storage system and the lifespan of the drives. In some cases, dealing with wear management may be straight forward, particularly if the drives are of a similar worn out level. However, for Mapped RAID, it may be more difficult as a storage pool can be extended incrementally drive by drive and the “older” drives can be worn out more than “younger” drives (N.B., the pool can be extended by “used” drives as well). As a result, in Mapped RAID, the respective drives that provide disk extents (DEs) to form RAID extents (REs) may have different endurance levels that result in some of these drives being worn out before other drives.

Storage systems may, therefore, consider different approaches in order to address this matter. For example, a storage system may consider a RE worn out level that is calculated using the endurance of the “weakest” DE. However, in these approaches, the write load that the RE can handle may have to be reduced and the storage system performance may be degraded as a result (problem #1). If the load is not reduced then the “weakest” drives may be worn out prematurely and possibly before the end of the warranty period (problem #2).

The approaches discussed herein in connection with Mapped RAID attempt to solve the above identified problems by reserving some spare space on at least some of the drives. For example, the spare space may be used for recovery in the event of drive failures. The spare space may also be distributed unevenly between the drives with more space reserved on the drives with less endurance. It should be understood that the reserved space increases the not used capacity of the drives and increases the effective endurance level of the drives. Thus, the endurance of the drives may be aligned, which addresses the two problems discussed in the previous paragraph.

Also, the approaches discussed herein enable an increase in the recovery speed as multiple drives can be written in parallel during a rebuild. As will be appreciated by those skilled in the art, the recovery speed does not grow after some level of parallelism because it gets limited by the other system resources (e.g., CPU, throughput of buses). So, by reserving space on a subset of drives only, it is possible to have a maximal available rebuild rate.

Also, another benefit of the approaches discussed herein is that it enables an increase in the capability of the drives and improves the system performance. It should be understood that the approaches avail of the fact that increasing the amount of not used capacity of an SSD increases the number of write-per-day (WPD) the drive supports because the drives uses the unused and unmapped capacity to balance wear.

Additionally, the system may monitor the parameters of the user load as it knows the amount of data written to it. This information is collected periodically. The system may also receive the endurance data from the drives periodically as well. The system knows the number of P/E cycles left to the end of the drive's endurance and the desired amount of time the drive should stand (e.g., the amount of time left to the end of the warranty period). It then identifies the drives, which are over worn in comparison to the other ones. The over worn term here can be used as “not able to handle the write load provided by the user I/O”.

It should be noted that approaches may be used in many different scenarios. For example, one possible scenario is when a system is initially provided by a set of drives, which have been worn out extensively due to high write load and a new set of drives is then added. The other scenario is installing used drives into the system. In these particular scenarios, the system distributes the spare space between drives not evenly and puts more of it to the drives with the less endurance level. The goal is to align the effective endurance level of all drives with a view to achieving a state where endurance of all drives is bigger than is required by the write load. The monitoring and analysis may be done periodically. The spare space may be redistributed as user load and drives health (endurance) changes.

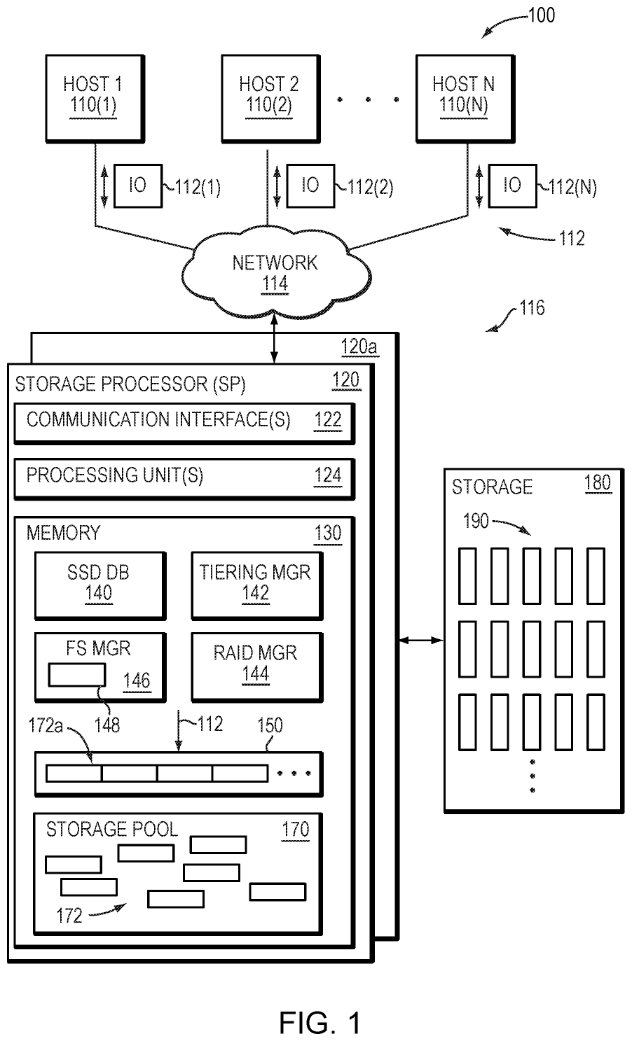

FIG. 1 shows an example environment 100 in which embodiments of an improved technique can be practiced. Here, host computing devices (“hosts”) 110(1) through 110(N) access a data storage system 116 over a network 114. The data storage system 116 includes a storage processor, or “SP,” 120 and storage 180. The storage 180 includes, for example, solid state drives (SSDs), magnetic disk drives, and/or optical drives and the like, which are arranged in a Mapped RAID configuration 190. As used herein, the terms “disk drive,” “disk,” and “drive” are intended to apply to storage drives of any type or technology, and thus describe magnetic disk drives, optical disk drives, SSDs, flash drives, and the like, even if such drives have no identifiable “disk.”

The SP 120 is seen to include one or more communication interfaces 122, a set of processing units 124, and memory 130. The communication interfaces 122 include, for example, SCSI drive adapters and network interface adapters, for converting electronic and/or optical signals received over the network 114 to electronic form for use by the SP 120. The set of processing units 124 includes one or more processing chips and/or assemblies. In a particular example, the set of processing units 124 includes numerous multi-core CPUs and associated co-processors and chipsets. The memory 130 includes both volatile memory (e.g., RAM), and non-volatile memory, such as one or more ROMs, disk drives, solid state drives, and the like. The set of processing units 124 and the memory 130 together form control circuitry, which is constructed and arranged to carry out various methods and functions as described herein. Also, the memory 130 includes a variety of software constructs realized in the form of executable instructions. When the executable instructions are run by the set of processing units 124, the set of processing units 124 are caused to carry out the operations defined by the software constructs. Although certain software constructs are specifically shown and described, it is understood that the memory 130 typically includes many other software constructs, which are not shown, such as an operating system, various applications, processes, and daemons.

The memory 130 is seen to “include,” i.e., to realize by execution of software instructions, a file system 150 and a storage pool 170. The storage pool 170 includes multiple extents 172, which provide units of storage that may be provisioned to file system 150. File system 150 is seen to include numerous provisioned extents 172a. In an example, each extent 172 (or 172a) is derived from the storage drives in storage 180 arranged in the Mapped RAID configuration 190. In some examples, each extent 172 is a relatively large increment of storage space, such as 256 MB or 1 GB in size.

It should be appreciated that the file system 150 is merely one type of data object to which the data storage system 116 may provision storage extents 172 from the pool 170. Other types of data objects may include, for example, volumes, LUNs (Logical UNits), virtual machine disks, and other types of data objects. Thus, embodiments of the improved techniques hereof are not limited to use with file systems but may be used with any data objects to which extents are provisioned.

The memory 130 is further seen to include an SSD database 140, a tiering manager 142, a RAID manager 144, and a file system manager 146. The SSD database 140 stores information about SSDs in the storage 180. This information may include estimated endurance values and, in some cases, performance data, such as accumulated errors, chip failures, and corresponding numbers of P/E (program/erase) cycles and times.

The tiering manager 142 performs storage tiering of data in the storage 180. In an example, different storage drives are arranged in respective storage tiers, with each storage tier providing a respective service level. For example, one storage tier may be derived from SSDs and another from magnetic disk drives. Multiple SSD tiers and/or magnetic disk drive tiers may be provided. In an example, the tiering manager 142 monitors activity on a per-extent 172a basis and automatically moves data between storage tiers, based on monitored activity. For example, if the data storage system 116 directs many reads and/or writes to a storage extent 172a derived from a magnetic tier, the tiering manager 142 may move the data from that extent 172a to an SSD tier, so that the data storage system 116 can operate more efficiently. Likewise, if the data storage system 116 rarely reads or writes data on an extent 172a derived from an SSD tier, the tiering manager 142 may move that rarely accessed data to a magnetic tier, as the space on the SSD tier could be more efficiently used by more frequently accessed data.

The RAID manager 144 organizes and maintains storage drives in storage 180 in a Mapped RAID configuration 190. For example, the RAID manager 144 creates a plurality of RAID extents from disk extents on multiple storage drives, maintains similar endurance across the SSDs by either reserving more or less space on drives based on endurance of the drives, manages rebuild of RAID extents, etc.

The file system manager 146 controls operations of the file system 150. In an example, the file system manager 146 includes performance data 148, which may provide, for example, numbers of writes to provisioned extents 172, amounts of data written, and times when those writes occurred. In an example, the file system manager 146 provides the performance data 148 to the tiering manager 142, which applies the performance data in performing automatic tiering of provisioned extents 172a.

In example operation, the hosts 110(1-N) issue IO requests 112(1-N) to the data storage system 116. The SP 120 receives the IO requests 112(1-N) at the communication interfaces 122 and initiates further processing. Such processing may include performing reads and writes to provisioned extents 172a in the file system 150. As the reads and writes proceed, the file system manager 146 accumulates new performance data pertaining to provisioned extents 172a. Also, the SSD database 142 accumulates new performance data pertaining to SSDs in the storage 180.

At some point during operation, SP 120 may generate estimates of endurance for some of all SSDs in the storage 180. For example, SP 120 may generate estimates from the accumulated performance data in the SSD database 140. In some cases, the SSD database 140 may already include endurance estimates for some SSDs, which may have been provided when the SSDs were first installed, for example. In some cases, the SP 120 may overwrite prior endurance estimates with new estimates, e.g., based on newly acquired performance data.

In an example, the RAID manager 144 receives the endurance estimates from the SSD database 140 and checks the SSDs in the Mapped RAID configuration 190. For drives lacking uniformity in endurance estimates, the RAID manager 144 may take action to promote endurance uniformity by distributing spare space among at least some of the drives based on endurance. For example, the RAID manager 144 may reserve more spare space on the drives with less endurance such that the reserved space increases the not used capacity of these drives and increases the effective endurance level of the drives.

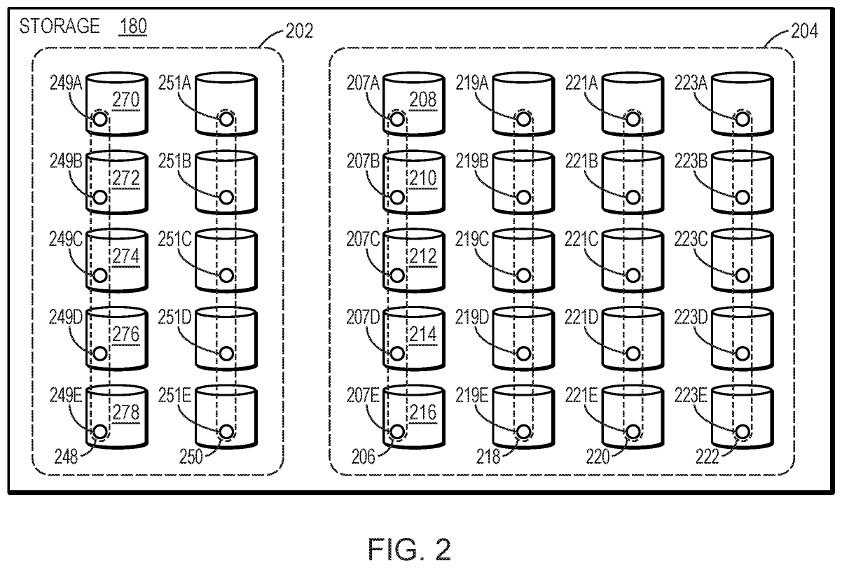

FIG. 2 shows one implementation of storage 180, wherein storage 180 is shown to include thirty storage drives. As is known in the art, the storage drives included within storage 180 may be grouped into different performance tiers. As discussed above, the various storage drives included within storage system 116 may include one or more electro-mechanical hard disk drives (which tend to have comparatively lower performance) and/or one or more solid-state/flash devices (which tend to have comparatively higher performance). Accordingly, storage 180 may be divided into a plurality of performance tiers (e.g., higher performance tier 202 and lower performance tier 204). While storage 180 is shown to include two performance tiers, this is for illustrative purposes only and is not intended to be a limitation of this disclosure, as other configuration are possible and are considered to be within the scope of this disclosure. For example, additional performance tiers may be added to further compartmentalize storage 180.

In this particular example, the ten storage drives shown to be included within higher performance tier 202 may be solid-state/flash devices (which tend to have comparatively higher performance) and/or the twenty storage drives shown to be included within lower performance tier 204 may be electro-mechanical hard disk drives (which tend to have comparatively lower performance). Accordingly, data that is frequently accessed within storage system 116 may be stored within higher performance tier 202, while data that is infrequently accessed within storage system 116 may be stored within lower performance tier 204.

At physical layer, the storage drives included within storage system 116 may be divided into a plurality of drive extents (e.g., portions), wherein each of these drive extents may have a capacity of 40-50 gigabytes. So if a storage drive has a capacity of 5.0 terabytes, this storage drive may include 100 drive extents that each have a capacity of 50 gigabytes. Accordingly, and in such a situation, the twenty storage drives included within lower performance tier 204 may cumulatively include 2,000 (100×20) drive extents.

The drive extents included within e.g., lower performance tier 204 may be uniquely grouped to form RAID extents. While the following discussion concerns higher performance tier 202 and lower performance tier 204 being configured in a RAID 5 (4+1) fashion, this is for illustrative purposes only and is not intended to be a limitation of this disclosure, as other configurations are possible and are considered to be within the scope of this disclosure. For example, higher performance tier 202 and lower performance tier 204 may be configured in various fashions that may adhere to a RAID X (Y+Z) format.

Accordingly, and for this example of a RAID 5 (4+1) configuration, five unique drive extents may be configured to form a single RAID extent, wherein the individual drive extents included within a RAID extent are from different storage drives and are only used in one RAID extent (i.e., a drive extent cannot be used in multiple RAID extents). For example, RAID extent 206 may be constructed using a drive extent (e.g., drive extents 207A, 207B, 207C, 207D, 207E) from each of storage drives 208, 210, 212, 214, 216, (respectively). This forming of RAID extents may be repeated until 400 RAID extents are formed from the 2,000 drive extents included within e.g., lower performance tier 204. Accordingly: RAID extent 218 may be constructed using drive extents 219A, 219B, 219C, 219D, 219E); RAID extent 220 may be constructed using drive extents 221A, 221B, 221C, 221D, 221E); and RAID extent 222 may be constructed using drive extents 223A, 223B, 223C, 223D, 223E). Additionally, with respect to the high performance tier 202, RAID extent 248 may, for example, be constructed using a drive extent (e.g., drive extents 249A, 249B, 249C, 249D, 249E) from each of storage drives 270, 272, 274, 276, 278, (respectively). Furthermore, RAID extent 250 may be constructed using drive extents 251A, 251B, 251C, 251D, 251E.

It should be noted that a further discussion of Mapped RAID may be found in U.S. patent application Ser. No. 15/799090, filed 31 Oct. 2017, entitled STORAGE SYSTEM AND METHOD, and U.S. patent application Ser. No. 15/968930, filed on 2 May 2018, and entitled METHOD, APPARATUS AND COMPUTER PROGRAM PRODUCT FOR MANAGING DATA STORAGE, and they are hereby incorporated by reference in their entirety.

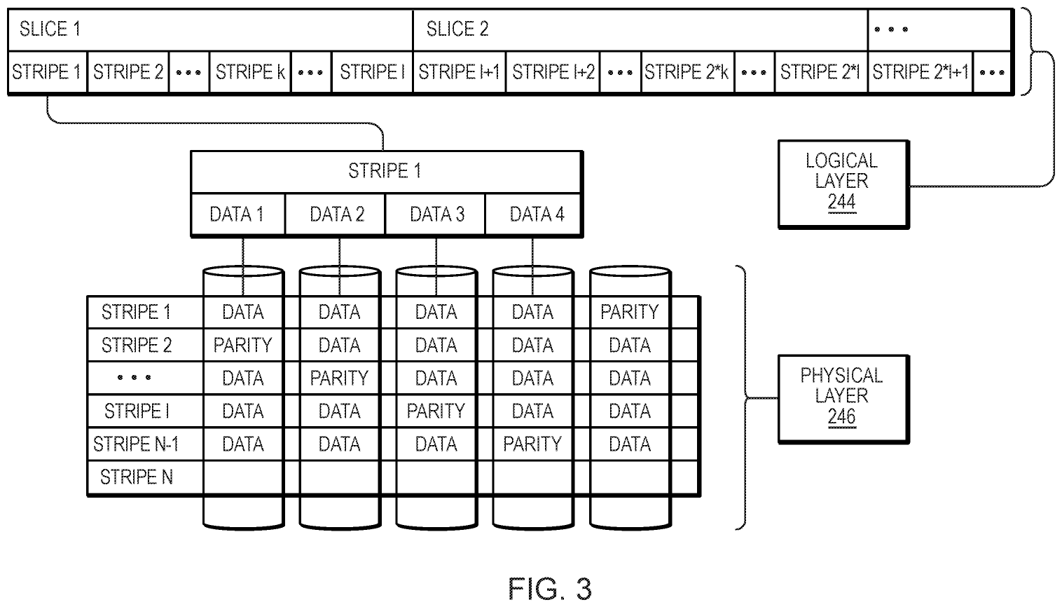

FIG. 3 shows one implementation of storage 180, wherein the storage system 116 may be configured to allow for the mapping of physical storage 246 to logical storage 244. Just as physical storage space (e.g., a storage drive) is divided into a plurality of smaller portions (e.g., drive extents), logical storage space is divided into a plurality of smaller portions (e.g., extents 172 which may also be referred to herein as data slices), wherein each of these data slices may have a capacity of e.g., 256 megabytes and may be mapped to underlying drive extents within the storage drives of (in this example) lower performance tier 204. Specifically, these data slices may be broken down into data stripes that have a common data capacity (e.g., 16 kilobytes, 32 kilobytes, 64 kilobytes, 128 kilobytes, 256 kilobytes or 512 kilobytes).

For example, and for illustrative purposes only, a 256 kilobyte data stripe for use within a RAID 5 (4+1) system may include four 64 kilobyte data segments and one 64 kilobytes parity segment (for a total of five segments) that would each be mapped to a distinct drive extent included with a RAID extent (as shown in FIG. 3). Accordingly and in this example, the five segments within a data stripe (e.g., four data segments and one parity segment) may be mapped to the five drive segments within a RAID segment, thus resulting in each of the five segments within a data stripe being written to a distinct storage drive. So if a 256 kilobyte data stripe was mapped to RAID extent 206, the first 64 kilobyte data segment may be written to drive extent 207A within storage drive 208, the second 64 kilobyte data segment may be written to drive extent 207B within storage drive 210, the third 64 kilobyte data segment may be written to drive extent 207C within storage drive 212, the fourth 64 kilobyte data segment may be written to drive extent 207D within storage drive 214, and the fifth 64 kilobyte parity segment may be written to drive extent 207E within storage drive 216.

And when mapping data slices onto storage drives (e.g., the storage drives included within higher performance tier 202 and/or lower performance tier 204), the first 256 kilobyte data stripe of the 256 megabyte data slice may be written to a first RAID extent (which spans five storage drives) . . . and the next 256 kilobyte data stripe of the 256 megabyte data slice may be written to a second RAID extent (which also spans five storage drives) . . . and the next 256 kilobyte data stripe of the 256 megabyte data slice may be written to a third RAID extent (which also spans five storage drives) . . . and so on for 1,000 iterations until the entire 256 megabyte data slice is written to various RAID extents within storage system 12. So being that a 256 megabyte data slice may be written to e.g., higher performance tier 202 and/or lower performance tier 204 as 1,000 separate 256 kilobyte data stripes that are stored on 1,000 separate RAID extents included in higher performance tier 202 and/or lower performance tier 204, it is foreseeable that a single data slice may be spread across every storage drive within higher performance tier 202 and/or lower performance tier 204.

Returning now to the earlier figures, and as discussed above, the system 116 checks the SSDs in the Mapped RAID configuration 190 to compare endurance estimates. For example, storage 180 may include ten SSDs in a Mapped RAID configuration as illustrated in the high performance tier 202. Each of the SSDs may have a respective estimated endurance value. Endurance values may have been generated recently in response to monitored performance data, for example, or may have been established at the time of installation. As used herein, endurance values are expressed in units of writes per day (WPD). Each unit of WPD describes a write of the entire contents of the SSD and may be calculated based on one or more of a service life, the number of P/E cycles remaining before it is expected to require replacement, and the logical and physical size of the drive. For example, in one embodiment, if a 1 TB (terabyte) SSD has an endurance value of 1 WPD and no reserved space, the entire 1 TB of the SSD may be rewritten 1 time every day for 5 years before the SSD is expected to wear out and require replacement. However, if the drive has 0.5 TB of the reserved space (and 1 TB of logical space) then the endurance value may be 1.5WPD. In some examples, WPD is expressed more formally as follows:

WPD=(X*Z)/(Y*K)
where X equals the number of remaining P/E (Program/Erase) cycles (max—current) before it is expected to require replacement,
where Y equals the logical size of the drive,
where Z equals the physical size of the drive, and
where K equals the number of remaining days to the end of the warranty period or its desired lifespan.

In one example embodiment, suppose there is ten SSDs in a Mapped RAID configuration, and the first nine SSDs have estimated endurance values of 3 WPD, and the tenth SSD 210 has an estimated endurance value of 2.9 WPD that is lower than the other SSDs. It should be understood that the status of the tenth SSD may have two consequences, both of which are undesirable. First, the lower endurance of SSD may cause premature failure. Second, the lower endurance of the SSD may cause the data storage system 116 to operate at a lower performance.

To avoid these undesirable consequences, the RAID manager 144 may check whether the tenth SSD has enough storage capacity in order to increase the reserved space of the tenth SSD so as to increase the WPD in order to achieve endurance uniformity in WPD across the storage drives in the Mapped RAID configuration. By increasing the reserved space, the WPD of the SSD may also increase. Here, the intent of increasing the WPD is to have drives with a WPD that yield a similar % wear with respect to their desired lifetime such that all drives last at least as long as their desired lifetime (which is their warrantee period). So, for example, if there is a 3 WPD drive that is supposed to last 5 years, but after 2.5 years it has only the equivalent of 2.9 WPD left, it may be desired to increase the capability of the drive to being, for example, a 3.0 WPD or a 3.1 WPD drive by reserving, and not using, space on the drive for the next 2.5 years assuming the drive will see the same write load.

It should be understood that when referring to a 3 WPD drive (what the drive is rated at) that has only the equivalent of 2.9 WPD capability left with regards to its desired lifetime it is meant that over the past 2.5 years the drive has received on average more than 3 WPD (i.e., it was written to more than what it was rated for wear wise). That drive is still a 3 WPD drive (in terms of the amount of writes it can handle from a wear perspective over 5 years based on its specification) but relative to its desired lifetime it can only really handle 2.9 WPD in terms of writes going forward in order to not “wear out” before its desired lifetime because in the past it was written to at a rate higher then 3 WPD. So, in order to handle the expected future write load (and in fact to even handle 3 WPD in terms of future writes), the drives write handling capability may need to be increased above its rated 3 WPD. For example, by increasing the 3 WPD drive's write handling capability from 3 WPD to 3.1 WPD through the use of reserved space, the intent is to handle the expected future write load.

It should be understood that in the above example the system has one SSD that is not consistent with the other SSDs. However, it should be understood that there may be inconsistency across numerous SSDs in the Mapped RAID configuration. The system 116, as a result, distributes the spare space between SSDs not evenly and puts more of it to the drives with less endurance with the goal of aligning the effective endurance level of all drives such that endurance of all drives is bigger than is required by the write load.

Additionally, if the SSD with low endurance does not have sufficient space to increase the spare capacity, the RAID manager may rebuild some of the REs that utilize DEs derived from that particular drive in order to facilitate an increase in the spare capacity of the drive. For example, a RE may have a DE associated with the low endurance drive. There may be numerous other, for example, high endurance drives in the Mapped RAID configuration that include spare DEs that could be utilized to rebuild the RE. The RAID manager may rebuild the REs by copying the relevant data to these DEs and freeing DEs on the low endurance drive. The RAID manager may, as a result, increase the spare capacity of the low endurance drive with a view to increasing the WPD of that drive.

Additionally, it should be understood that although we have discussed endurance uniformity across the drives in the Mapped RAID configuration it may be that the system attempts to achieve endurance uniformity across a subset of the drives. For example, there may be drives newly added with high endurance that have endurance significantly greater than drives that have been used over a number of years. The systems may, therefore, attempt to achieve endurance uniformity between different sets of drives based on their age. The system may also direct the very high loads to the high endurance set of drives and lower loads to the low endurance set of drives.

Further, it should be appreciated that endurance values of SSDs may change over time, and that endurance values of different SSDs may change at different rates. For example, after a period of time passes, such as 1 year, the SP 120 may regenerate endurance values, e.g., based on performance data accumulated over the prior year and/or based on other information. If any SSD is detected to have a low endurance value relative to other SSDs in the Mapped RAID configuration, the RAID manager 144 may perform the above steps in order to create endurance uniformity across the drives.

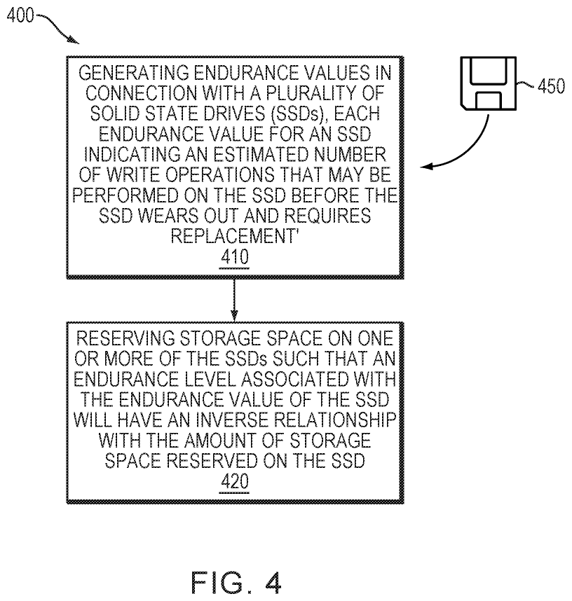

FIG. 4 shows an example method 400 for managing SSDs in a data storage system. The method 400 may be carried out, for example, by the software constructs shown in FIG. 1, which reside in the memory 130 of SP 120 and are run by the set of processing units 124. The acts of method 400 may be ordered in any suitable way. Accordingly, embodiments may be constructed in which acts are performed in an order different from that illustrated, which may include performing some acts simultaneously.

At step 410, generating endurance values in connection with a plurality of solid state drives (SSDs). Each endurance value for an SSD indicating an estimated number of write operations that may be performed on the SSD before the SSD wears out and requires replacement. At step 420, reserving storage space on one or more of the SSDs such that an endurance level associated with the endurance value of the SSD will have an inverse relationship with the amount of storage space reserved on the SSD.

Having described certain embodiments, numerous alternative embodiments or variations can be made. Further, although features are shown and described with reference to particular embodiments hereof, such features may be included and hereby are included in any of the disclosed embodiments and their variants. Thus, it is understood that features disclosed in connection with any embodiment are included as variants of any other embodiment.

Further still, the improvement or portions thereof may be embodied as a computer program product including one or more non-transient, computer-readable storage media, such as a magnetic disk, magnetic tape, compact disk, DVD, optical disk, flash drive, SD (Secure Digital) chip or device, Application Specific Integrated Circuit (ASIC), Field Programmable Gate Array (FPGA), and/or the like (shown by way of example as medium 450 in FIG. 4). Any number of computer-readable media may be used. The media may be encoded with instructions which, when executed on one or more computers or other processors, perform the process or processes described herein. Such media may be considered articles of manufacture or machines, and may be transportable from one machine to another.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Further, although ordinal expressions, such as “first,” “second,” “third,” and so on, may be used as adjectives herein, such ordinal expressions are used for identification purposes and, unless specifically indicated, are not intended to imply any ordering or sequence. Thus, for example, a second event may take place before or after a first event, or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Although certain embodiments are disclosed herein, it is understood that these are provided by way of example only and that the invention is not limited to these particular embodiments.

Those skilled in the art will therefore understand that various changes in form and detail may be made to the embodiments disclosed herein without departing from the scope of the invention.

1. A method, comprising:
generating endurance values in connection with a plurality of solid-state drives (SSDs), each endurance value for an SSD indicating an estimated number of write operations that may be performed on the SSD before the SSD wears out and requires replacement;
reserving storage space on one or more of the SSDs such that an endurance level associated with the endurance value of the SSD will have an inverse relationship with the amount of storage space reserved on the SSD;
determining an amount of program/erase (P/E) cycles left to an end of each SSD's endurance and a desired amount of life of each SSD; and
controlling loads directed to each of the SSDs based on the determined amount of P/E cycles and the desired amount of life of each SSD.

2. The method as claimed in claim 1, wherein reserving storage space comprises determining an amount of storage space to be reserved on the respective one or more SSDs in order to facilitate endurance uniformity across the plurality of SSDs.

3. The method as claimed in claim 1, wherein reserving storage space comprises identifying one or more of the SSDs that have an endurance level associated with the endurance value that is different to the other SSDs of the plurality of SSDs and determining to increase or decrease an amount of storage space reserved on the respective one or more SSDs in order to facilitate endurance uniformity across the plurality of SSDs.

4. The method as claimed in claim 1, wherein reserving storage space on one or more of the SSDs to enable a corresponding percentage wear with respect to the lifetime of the respective SSDs such that the SSDs remain operational for the lifetime.

5. The method as claimed in claim 1, wherein the endurance values arc generated for a plurality of SSDs having corresponding endurance ratings.

6. The method as claimed in claim 1, wherein the endurance values generated in connection with the SSDs are expressed in units of writes per day (WPD).

7. A data storage system, comprising control circuitry that includes a set of processing units coupled to memory, the control circuitry constructed and arranged to:
generate endurance values in connection with a plurality of solid-slate drives (SSDs), each endurance value for an SSD indicating an estimated number of write operations that may be performed on the SSD before the SSD wears out and requires replacement;
reserve storage space on one or more of the SSDs such that an endurance level associated with the endurance value of the SSD will have an inverse relationship with the amount of storage space reserved on the SSD;
determine an amount of program/erase (P/B) cycles left to an end of each SSD's endurance and a desired amount of life of each SSD; and
control loads directed to each of the SSDs based on the determined amount of P/E cycles and the desired amount of life of each SSD.

8. The data storage system as claimed in claim 7, wherein reserving storage space comprises determining an amount of storage space to be reserved on the respective one or more SSDs in order to facilitate endurance uniformity across the plurality of SSDs.

9. The data storage system as claimed in claim 7, wherein reserving storage space comprises identifying one or more of the SSDs that have an endurance level associated with the endurance value that is different to the other SSDs of the plurality of SSDs and determining to increase or decrease an amount of storage space reserved on the respective one or more SSDs in order to facilitate endurance uniformity across the plurality of SSDs.

10. The data storage system as claimed in claim 7, wherein reserving storage space on one or more of the SSDs to enable a corresponding percentage wear with respect to the lifetime of the respective SSDs such that the SSDs remain operational for the lifetime.

11. The data storage system as claimed in claim 7, wherein the endurance values are generated for a plurality of SSDs having corresponding endurance ratings.

12. The data storage system as claimed in claim 7, wherein the endurance values generated in connection with the SSDs are expressed in units of writes per day (WPD).

13. A computer program product including a set of non-transitory, computer-readable media having instructions which, when executed by control circuitry of a data storage system, cause the control circuitry to perform a method, the method comprising:
generating endurance values in connection with a plurality of solid-state drives (SSDs), each endurance value for an SSD indicating an estimated number of write operations that may be performed on the SSD before the SSD wears out and requires replacement;
reserving storage space on one or more of the SSDs such that an endurance level associated with the endurance value of the SSD will have an inverse relationship with the amount of storage space reserved on the SSD;
determining an amount of program/erase (P/E) cycles left to an end of each SSD's endurance and a desired amount of life of each SSD; and
controlling loads directed to each of the SSDs based on the determined amount of P/E cycles and the desired amount of life of each SSD.

14. The computer program product as claimed in claim 13, wherein reserving storage space comprises determining an amount of storage space to be reserved on the respective one or more SSDs in order to facilitate endurance uniformity across the plurality of SSDs.

15. The computer program product as claimed in claim 13, wherein reserving storage space comprises identifying one or more of the SSDs that have an endurance level associated with the endurance value that is different to the other SSDs of the plurality of SSDs and determining to increase or decrease an amount of storage space reserved on the respective one or more SSDs in order to facilitate endurance uniformity across the plurality of SSDs.

16. The computer program product as claimed in claim 13, wherein reserving storage space on one or more of the SSDs to enable a corresponding percentage wear with respect to the lifetime of the respective SSDs such that the SSDs remain operational for the lifetime.

17. The computer program product as claimed in claim 13, wherein the endurance values are generated for a plurality of SSDs having corresponding endurance ratings.

18. The computer program product as claimed in claim 13, wherein the endurance values generated in connection with the SSDs are expressed in units of writes per day (WPD).
